(19) United States
(12) Patent Application Publication
(10) Pub. No.: US 2008/0102870 A1
(43) Pub. Date: May 1, 2008

(54) Push-To-Talk-Over-Cellular (Poc) Method

(75) Inventors: Petr Gothard, Brno (CZ); Petr Klika, Dolni Kounice (CZ); Martin Palecek, Brno (CZ); Ivo Sedlacek, Kurim (CZ)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/663,255

(22) PCT Filed: May 17, 2005
(86) PCT No.: PCT/EP05/52233

§ 371 Date: Apr. 5, 2007

(30) Foreign Application Priority Data
Sep. 17, 2004 (DE) 10 2004 045 193.1

(51) Int. Cl. H04B 7/00

(52) U.S. Cl. 455/518

(57) ABSTRACT

A method for communicating in a radio-communication system including an infrastructure network and user stations, wherein the infrastructure network enables the user stations to communicate by way of a so-called push-to-talk method wherein messages can be transmitted using a first type of recipient-identification information to a plurality of user stations and, using a second type of recipient-identification information, to individual user stations. In response to a request relating to specific recipient-identification information, information about the type of specific recipient-identification information is sent to a user station by the infrastructure network.

The invention relates to a method for communicating in a radio-communication system whose infrastructure network enables user stations to communicate by means of a Push-to-Talk method.

In radio-communication systems, information that includes, for example, voice information, image information, video information, or SMS (Short Message Service), MMS (Multimedia Messaging Service), and other data is transmitted over a radio interface between a sending and receiving station with the aid of electromagnetic waves. Depending on how the radio-communication system is specifically embodied, said stations can therein be different types of—in particular mobile—user stations or radio devices in the infrastructure network such as, for instance, base stations. The electromagnetic waves are radiated using carrier frequencies in the frequency band provided for the respective system.

It is as a rule possible during voice communication between two user stations in a radio-communication system for each user to simultaneously be able to talk and also hear the other user. With the Push-to-Talk-over-Cellular (PoC) service a user can—as a rule after pressing a special key—convey a voice message to one or more recipients simultaneously, with that taking place virtually in realtime. PoC is based on the half-duplex method so that the recipient or recipients cannot interrupt the sender while he or she is talking. Before PoC communication can take place, the user initiating PoC communication provides the infrastructure network with recipient-identification information identifying an individual user or group of users to whom the user's PoC messages containing audio content will in the ensuing be sent in the course of PoC communication.

The object of the invention is to disclose an efficient method for communicating by radio in a radio-communication system whose infrastructure network enables user stations to communicate by means of a Push-to-Talk method. Its further object is to disclose a suitable user station and a suchlike infra-structure network for implementing said method.

Said objects are achieved by means of a method having the features of claim 1 and by means of devices having the features of ancillary claims. Advantageous embodiments and developments are the subject of subclaims.

With the inventive method the infrastructure network enables the user stations to communicate by means of a Push-to-Talk method with which messages can be transmitted using a first type of recipient-identification information to a plurality of user stations and, using a second type of recipient-identification information, to individual user stations. According to the invention, in response to a request relating to specific recipient-identification information, information about the type of specific recipient-identification information is sent to a user station by the infrastructure network.

The radio-communication system's infrastructure network can include radio stations such as, for instance, base stations, that communicate directly with the user stations, as well as servers for implementing various services such as, for example, Push-to-Talk, referred to also as Push-to-Talk-over-Cellular. Push-to-talk is a service known per se with which a user can exchange messages with one or more other users employing a half-duplex method. The recipients of the messages dispatched by the user are uniquely identified and addressable by means of recipient-identification information. A first type of recipient-identification information is used for identifying a group consisting of a plurality of users and a second type is used for identifying individual users. The two types of recipient-identification information differ at least in respect of their being used for identifying individual users or a group. There may be further differentiating features, but the format of both types of recipient-identification information can in particular be identical so that it cannot be decided on the basis of the format whether particular recipient-identification information is recipient-identification that relates to an individual user or to a group.

For example the recipient-identification information for a team coach, which is to say recipient-identification information for identifying an individual user, could be:

<sip:team.coach@example.com>, while the recipient-identification information for the team group consisting of a plurality of members is: <sip:team.mates@example.com>. In terms of syntax, there is no difference between said two items of recipient-identification information.

The request is preferably dispatched by the user station. Said request can explicitly request the information about the type of specific recipient-identification information; it can also partly or exclusively contain a request for a variable other than the information about the type of specific recipient-identification information. In response to the request, information about the type of specific recipient-identification information will be sent to the user station by the infrastructure network. The message containing said information can be produced in the infrastructure network and dispatched by it to the user station, but it is also possible for the infrastructure network to receive the information from, for instance, another user station and forward it, where applicable in revised form, to the user station. The information about the type of specific recipient-identification information makes it possible to uniquely decide whether the specific recipient-identification information is recipient-identification information of the first or second type. The information about the type of specific recipient-identification information can contain details of the type of recipient-identification information either explicitly or else implicitly in the form of details of another variable from which the information about the type of specific recipient-identification information can be read or deduced.

In a development of the invention the request is sent automatically by the user station after a user has entered the specific recipient-identification information into the user station. Thus the user of the user station indicates the specific recipient-identification information by performing, for example, a keying-in or selection operation or suchlike, whereupon the user station will send the request automatically, which is to say without being requested to do so by the user. Dispatching of the request can possibly be preceded by a step of the method at which the user station checks whether the type of specific recipient-identification information is known to it and will dispatch a request only if said type is not known to it.

According to an advantageous development of the invention, after receiving the information about the type of specific recipient-identification information the user station sends a message such as, for example, what is termed an SIP INVITE message for initiating Push-to-Talk communication with the user or users indicated by the specific recipient-identification information, with the message being produced using the information about the type of specific recipient-identification information. That will be favorable particularly if initiating by the user station of Push-to-Talk communication with the user or users in accordance with the specific recipient-identification information will only be possible if the type of specific recipient-identification information is known to the user station. It will be advantageous if, after the information about the type of specific recipient-identification information has been dispatched, the infrastructure network receives a message produced using said information by the user station for initiating Push-to-Talk communication with the user or users indicated by the specific recipient-identification information.

According to an embodiment of the invention the information about the type of specific recipient-identification information is in the case of recipient-identification information of the first type produced by the infrastructure network and sent to the user station, and is in the case of recipient-identification information of the second type produced by the user station of the respective user indicated by the specific recipient-identification information and sent to the user station over the infrastructure network. The information about the type of specific recipient-identification information thus in both cases traverses the infrastructure network, though in the second case said information is not dispatched originally by the infrastructure network but by a user station.

It is particularly advantageous for the request to be an SIP OPTIONS message standardized in conformity with the SIP protocol. The information about the type of specific recipient-identification information can be contained in a standardized 200 OK message.

The inventive user station has means for communicating by means of a Push-to-Talk method with which messages can be transmitted using a first type of recipient-identification information to a plurality of further user stations and, using a second type of recipient-identification information, to individual further user stations, as well as means for dispatching a request, relating to specific recipient-identification information, for information about the type of specific recipient-identification information, and means for receiving and processing information about the type of specific recipient-identification information.

The inventive infrastructure network has means for enabling communication by user stations by means of a Push-to-Talk method with which messages can be transmitted using a first type of recipient-identification information to a plurality of user stations and, using a second type of recipient-identification information, to individual user stations, as well as means for receiving a request, relating to a specific recipient-identification information, from a user station for information about the type of specific recipient-identification information, and means for dispatching information about the type of specific recipient-identification information to the user station.

As already explained above, the request for information about the type of specific recipient-identification information can request said information directly, or also implicitly or indirectly through the request's being interpretable only through interaction with the evaluation of the received response to the request as being a request for said information.

The inventive devices are in particular suitable for implementing the inventive method, with that applying also to the embodiments and developments. Further suitable means can be provided for this purpose.

The invention is described in more detail below with the aid of an exemplary embodiment.

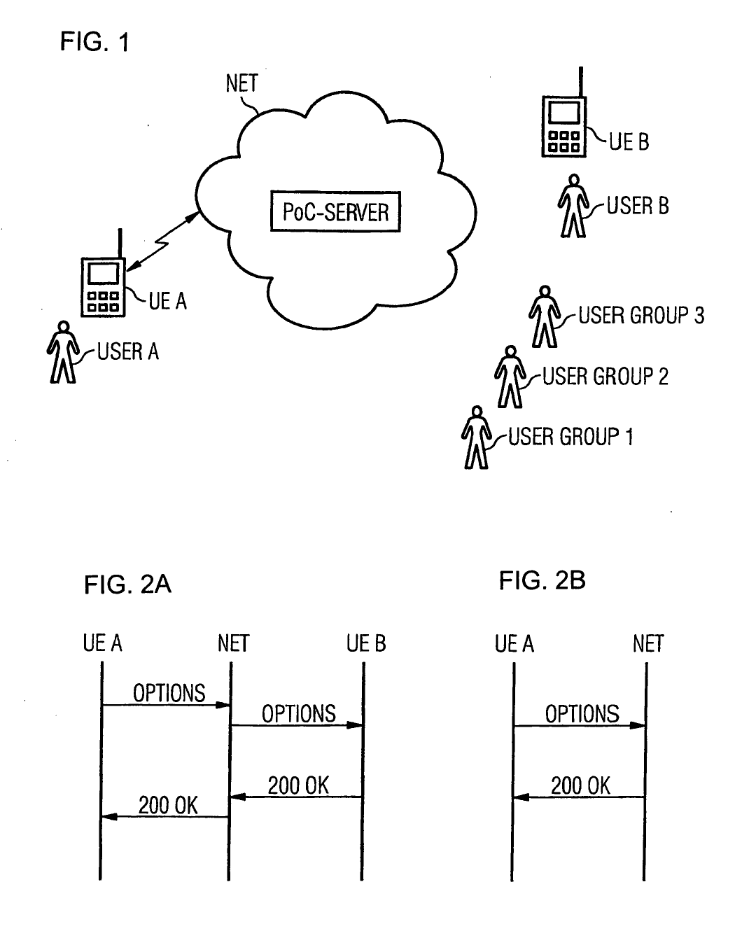

FIG. 1: shows a radio-communication system,

FIG. 2a: shows a first flowchart of the inventive method,

FIG. 2b: shows a second flowchart of the inventive method.

The radio-communication system that is shown in FIG. 1 and which can be embodied according to, for example, the UMTS (Universal Mobile Telecommunications System) standard includes a user station UE A (UE: User Equipment) of a user USER A, and an infrastructure network NET having the infrastructure necessary for user stations' communication such as, for example, the server PoC-SERVER, which is responsible, where applicable in combination with further devices, for the Push-to-Talk-over-Cellular service, abbreviated below to PoC. The server PoC-SERVER is a constituent part of the IMS (IP Multimedia Subsystem), which is described in, for example
3GPP TS 23.228 V5.7.0 (2002-12): IP Multimedia Subsystem (IMS); Stage 2 (Release 5).

Within the framework of PoC the user USER A can communicate with an individual further user USER B having a user station UE B or with a group of further users USER GROUP 1, USER GROUP 2, USER GROUP 3 having their respective user stations (not shown). The user USER A initiating PoC communication sends for this purpose what is termed an SIP INVITE message to the infrastructure network NET. The SIP INVITE message contains recipient-identification information of the further user USER B or, as the case may be, recipient-identification information for the group consisting of the users USER GROUP 1, USER GROUP 2, USER GROUP 3. The group's recipient-identification information is a single item of recipient-identification information, not individual recipient-identification information of the members of the group. With SIP URI (SIP: Session Initiation Protocol, URI: Uniform Resource Identifier), the recipient-identification information has the same format irrespective of whether an individual user or a group is addressed therewith. The SIP INVITE message requiring to be dispatched nonetheless differs in the case of an individual user as the recipient of PoC communication from that in the case of a group of recipients. If a group is addressed, the recipient-identification information will be contained in the field or, as the case may be, attribute “To”, while in the case in which an individual user is addressed the recipient-identification information will be contained in the field or, as the case may be, attribute “Refer To”.

It must therefore be known to the user station UE A before the SIP INVITE message is dispatched whether the recipient-identification information relates to an individual user or to a group. An instance of how that can be realized is for the user USER A to enter these details into the user station UE A or to select an address entry from an address book, used for groups or alternatively for individual users, of the user station UE A. That, though, is on the one hand tedious for the user USER A and, on the other, said details may possibly be unavailable to the user USER A such as in a case where, say, the user USER A takes recipient-identification information of PoC recipients unknown to him or her from an internet page or magazine publication so that he or she will not know whether said recipient-identification information relates to an individual recipient or to a group.

According to the invention the user station UE A will, in order to determine the missing information, automatically dispatch a request to the infrastructure network NET when the user USER A provides recipient-identification information for establishing PoC communication regarding which it is not known to the user station UE A whether said information relates to an individual user or to a group. That will be explained in more detail below on the basis of dispatching what is termed an “SIP OPTIONS” message. That is a message conforming to the SIP standard described in, for example,
J. Rosenberg, H. Schulzrinne, G. Camarillo, A. Johnston, J. Peterson, R. Sparks, M., Handley, E. Schooler: “SIP: session initiation protocol”, RFC 3261, Internet Engineering Task Force, March 1999.

Capabilities of servers and terminals are customarily interrogated by means of an SIP OPTIONS message.

The user station UE A dispatches an SIP OPTIONS message and into the recipient-field thereof inserts the recipient-identification information whose type is to be determined. If the recipient-identification information relates to the individual recipient USER B, then the SIP OPTIONS message OPTIONS will, as shown in FIG. 2a, be forwarded by the infrastructure network NET to the user station UE B. If, conversely, the recipient-identification information relates, as shown in FIG. 2b, to a group, then no forwarding of the SIP OPTIONS message OPTIONS by the infrastructure network NET will take place. The infrastructure network NET will in that case instead be the recipient of the SIP OPTIONS message OPTIONS.

The recipient customarily responds to the receipt of an SIP OPTIONS message OPTIONS by dispatching a response message 200 OK. In the case shown in FIG. 2a the response message 200 OK is dispatched by the user station UE B, with the response message 200 OK being forwarded by the infrastructure network NET to the user station UE A, while in the case shown in FIG. 2b the response message 200 OK is dispatched by the infrastructure network NET.

The header of the response message 200 OK contains information about which device originally dispatched the response message 200 OK. For example the response message 200 OK shown in FIG. 2a contains an entry “PoC-MS” indicating that the response message 200 OK was produced by a user station. In the case shown in FIG. 2b the response message 200 OK contains an entry “PoC-SERV” indicating that the response message 200 OK was produced by a PoC server. It is known to the user station UE A that if recipient-identification information relating to an individual user is used for identifying the recipient of the SIP OPTIONS message OPTIONS, then an SIP OPTIONS message OPTIONS will be sent to the respective user station and answered by it. The user station UE A can therefore infer from the response message 200 OK having the entry “PoC-MS” that the recipient-identification information in the SIP OPTIONS message OPTIONS is recipient-identification information relating to an individual user. It is further known to the user station UE A that an SIP OPTIONS message OPTIONS will be answered by the infrastructure network NET if recipient-identification information relating to a group of users is used for identifying the recipient of the SIP OPTIONS message OPTIONS. The user station UE A can then infer from the response message 200 OK having the entry “PoC-SERV” that the recipient-identification information in the SIP OPTIONS message OPTIONS is recipient-identification information relating to a group.

If a response message 200 OK contains an entry other than “PoC-SERV” or “PoC-MS”, then the response message 200 OK was produced by a non-PoC-compatible device. It will in that case not be possible to initiate and establish PoC communication with reference to the respective recipient-identification information. If a message other than a response message 200 OK is received in response to the SIP OPTIONS message OPTIONS, then the recipient-identification information in the SIP OPTIONS message OPTIONS will be regarded as invalid and no PoC communication with reference to the respective recipient-identification information will be initiated by the user station UE A.

The invention places no special requirements on the structure of the SIP OPTIONS messages; this can be produced and dispatched in accordance with the above-cited document RC3261. According to the invention only the relevant recipient-identification information will be inserted into the recipient-field of the SIP OPTIONS message. Nor does the inventive use of the 200 OK messages place any special requirements on the structure of said messages; this can be produced and dispatched in accordance with the above-cited document RC3261. Said message can contain the specified “+g.poc.talkburst flag”. Messages already used within the scope of PoC can therefore be employed for determining the type of recipient-identification information. The inventive method can, though, also be realized using other messages such as, for example, SIP INVITE messages having a data field created for the purposes of the invention, or messages hitherto not used for PoC.

The method can be employed in an infrastructure network NET having a plurality of PoC domains, with each domain administering recipient-identification information of a plurality of users. Each domain can therein include, for example, the devices known per se: P-CSCF (Proxy Call State Controlling Function) server, constituting the point of contact with the user stations, PoC server, S-CSCF (Serving Call State Control Function) server, and I-CSCF (Interrogating Call State Control Function) server, which receives and forwards SIP OPTIONS messages from other domains. If an SIP OPTIONS message is dispatched by a user assigned to a first domain with recipient-identification information of a user assigned to a second domain, then the SIP OPTIONS message will be received by the first domain and forwarded to the second domain. The second domain will forward the SIP OPTIONS message to the respective user, corresponding to the recipient-identification information, who will thereupon dispatch a 200 OK response message that will be forwarded to the user of the first domain. If an SIP OPTIONS message is dispatched by a user assigned to a first domain with recipient-identification information of a group assigned to the second domain, then the SIP OPTIONS message will be received by the first domain and forwarded to the second domain, which will dispatch a 200 OK response message that will be forwarded to the user of the first domain. From the header of the 200 OK response message it can in both cases be inferred by which device the 200 OK response message was originally dispatched.

1-8. (canceled)

9. A method for communicating in a radio-communication system with an infrastructure network and user stations, the method which comprises:
enabling the user stations to communicate by way of a push-to-talk method in the infrastructure network for transmitting messages to a plurality of user stations using a first type of recipient-identification information and transmitting messages to individual user stations using a second type of recipient-identification information; and
in response to a request relating to specific recipient-identification information, sending information about the type of specific recipient-identification information to a user station by the infrastructure network.

10. The method according to claim 9, which comprises automatically sending the request from the user station after a user has entered the specific recipient-identification information into the user station.

11. The method according to claim 9, which comprises, after receiving the information about the type of specific recipient-identification information, generating a message with the user station using the information and sending the message for initiating push-to-talk communication with the user or users indicated by the specific recipient-identification information.

12. The method according to claim 9, which comprises, after having dispatched the information about the type of specific recipient-identification information, receiving with the infrastructure network a message generated by the user station using the information for initiating push-to-talk communication with the user or users indicated by the specific recipient-identification information.

13. The method according to claim 9, which comprises:
in a case of recipient-identification information of the first type, producing the information about the type of specific recipient-identification information with the infrastructure network and sending the information to the user station; and
in a case of recipient-identification information of the second type, producing the information about the type of specific recipient-identification information with the user station of a respective user indicated by the specific recipient-identification information and sending the information to the user station over the infrastructure network.

14. The method according to claim 9, wherein the request is a SIP OPTIONS message standardized to Session Initiation Protocol.

15. A user station for communicating in a radio-communication system including an infrastructure network and further user stations, the user station comprising:
means for communicating with further user stations by way of a push-to-talk method, wherein messages are transmitted to a plurality of further user stations using a first type of recipient-identification information, and messages are transmitted to individual further user stations using a second type of recipient-identification information;
means for dispatching a request, relating to specific recipient-identification information, for information about a type of specific recipient-identification information; and
means for receiving and processing information about the type of specific recipient-identification information.

16. An infrastructure network for a radio-communication system, comprising:
means for enabling communication between user stations with of a push-to-talk method, wherein messages are transmitted to a plurality of user stations using a first type of recipient-identification information, and messages are transmitted to individual user stations using a second type of recipient-identification information;
means for receiving a request, relating to a specific recipient-identification information, from a user station for information about the type of specific recipient-identification information; and
means for dispatching information about the type of specific recipient-identification information to the user station.
